(19) United States
(12) Patent Application Publication
(10) Pub. No.: US 2005/0015925 A1
(43) Pub. Date: Jan. 27, 2005

(54) Sliding and swiveling door leaf element

(76) Inventors: Markus Bischof, Au (CH); Stefan Rechsteiner, Staad (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/496,877

(22) PCT Filed: Nov. 26, 2002
(86) PCT No.: PCT/EP02/13273

(30) Foreign Application Priority Data
Nov. 26, 2001 (DE) 101578059

(51) Int. Cl. E05D 15/06

(52) U.S. Cl. 16/96 D

(57) ABSTRACT

The invention relates to door leaf element for a sliding door system, which is characterized in that the door leaf element (2) can be slid along a guide rail (7, 42) and can be swiveled about a first and a second swivel axis (25). A door closer (16) forms an integral part of the door leaf element (2) and/or an arm of a lever (12, 13) is disposed in the door leaf element. The door leaf element (2) is guided by means of guiding elements (9) in an upper and a lower end area.

The present invention pertains to a door leaf element, especially for a sliding wall system, where the door leaf element can slide along a guide rail and simultaneously swivel around an axis of rotation.

Door leaf elements of the type in question are known from multi-leaf entry doors, from the sliding wall elements used as room dividers, and from the wall elements used in the front of buildings, especially restaurants and shops, to keep the commercial area either freely accessible or closed off, depending on the weather. The individual leaf elements can be parked at the side, so that the entering public will not encounter any obstacles. In this case the wall elements are frequently arranged parallel to each other, each in its own offset rail, along which the element can be pushed, or they are connected to hinges, so that they can be collapsed in accordion fashion. It is also known that a door can be provided within these sliding wall elements. So that this door does not remain open in the cold seasons after the front wall has been assembled, these doors are also equipped with door closers. The door closer is set into the floor and is connected to the door leaf above by an axis, which projects up from the floor. This connection is usually achieved by means of a projecting axis outlet of the door closer. This is a source of danger after the wall has been brought into its parking position, however, because then the connector is left projecting above the floor. Nor do the known door leaf elements make it possible for the door to be installed at any desired position in the overall wall system, because its position is always determined by the location of the door closer installed in the floor.

A horizontal sliding wall which consists of several sliding wall elements and in which a frame door closer is installed within an additional profiled section of one of the elements is described in EP 0 601 326 B1. The frame door closer in this case has a drive axle pointing toward the floor, through which a continuous bore passes at a right angle to the wall. A connecting pin, which is attached to the hardware fittings of the door, is premounted on the door leaf and engages in this bore. An advantage over the previously cited conventional door closer in the floor is that there is no need for any complicated alignment procedures in the floor area for the cement box of the door closer. Nevertheless, a frame door closer of this type requires a wide profiled section in addition to the standard sections; such a wide additional section cannot be incorporated into all sliding wall designs, however, because an element of this type with a frame door closer takes up a very large amount of space, which is not available, for example, at the entrance to a railway station.

There is also a hand-actuated locking device in the floor area, which must be latched, and a previously closed locking device in the upper area of the frame door closer must be mechanically opened. These operations are very cumbersome.

A sliding and swiveling door, which . . . of two sliding leaves to which swiveling side parts are connected is described in German Registered Design No. 94 21 374. Door closers, which are concealed inside the upper transverse sections, are installed inside the swiveling side parts.

It is therefore the task of the present invention to provide a sliding and swiveling door leaf element, which can be produced easily and at low cost and which allows the door leaf element to swivel in any desired position.

The task is accomplished by a door leaf element with the features of one of claims 1-3. The subclaims present advantageous elaborations of the invention.

The door leaf element according to the invention is designed so that it can slide along guide rails and can be swiveled at any desired position around a first and a second swivel axis. For this purpose, at least one lever arm is provided in the door leaf element, and the door leaf element is guided by guide elements in a floor rail at the bottom and in a ceiling rail at the top. As a result of this arrangement according to the invention, the door leaf element swivels both around the lever arm and also around the guide elements, which travel along the guide rails as the door leaf element continues to swivel. According to the invention, the main closing edge of the door leaf element thus traces an elliptical path. Because the door leaf element is guided at both the top and bottom, it is well supported as it swivels.

According to another, preferred embodiment of the present invention, a sliding and swiveling door leaf element has a door closer, which is integrated into the door leaf element. In other words, the door closer slides and/or swivels in common with the door leaf element. Thus the door leaf element can be moved to any desired position, and no matter where it is, it can always be closed by the door closer.

According to another preferred embodiment of the present invention, the sliding and swiveling door leaf element has both an integral door closer and also at least one lever arm. As a result, the door leaf element according to the invention can be pushed to any desired position and used as a door with its own door closer to support the closing movement. The lever arm supports the opening and closing movement of the door.

According to an especially preferred embodiment of the present invention, the lever arm is connected to the door closer.

To improve the stability of the swiveling movement of the door leaf element even more, the door leaf element preferably has two lever arms, one at the top of the door leaf and one at the bottom. It is also possible, however, for the door leaf element to have only one lever arm, either at the top or at the bottom.

To provide an especially compact design, the lever arm or arms of the door leaf element are preferably installed in a cutout area in one of the profiled sections of the door leaf.

It is especially preferred for the door leaf element according to the invention to have a profiled attachment section and, immediately adjacent thereto, a profiled leaf section, the door closer being installed in the leaf section.

It is especially preferred for the door closer to be concealed. Thus the attachment section and the leaf section are arranged parallel to each other, either at the top or at the bottom of the door leaf element.

It is also preferred to provide at least one swivel bearing for the door leaf element on an adjacent door leaf element of the sliding wall system. This other swivel bearing is preferably provided in the attachment section.

It is especially preferred to provide a slide rail in the attachment section. A traveling carriage is preferably installed in the slide rail. The carriage is preferably connected to the leaf of the door leaf element by means of a swinging mount. It should be noted that, in this inventive embodiment of the door leaf element, both the door leaf and the attachment section and the leaf section which is directly connected to the leaf is comprised. The door leaf element according to the invention and the adjacent door leaf elements belonging to the sliding wall system are preferably guided in the same rails. As a result, the construction effort can be reduced, because only one rail is required in the ceiling and one in the floor; in addition, the highest aesthetic requirements are also fulfilled.

So that the door leaf element can be actuated and especially swiveled reliably, an arresting device is preferably provided. As a result, the door leaf element according to the invention can be locked in position at any desired point along the guide rails. This guarantees the reliable actuation of the door. For example, when the sliding wall system is used in front of a shop, only half of the wall system can be opened, and the sliding and swiveling door leaf element can be set up at any desired point.

So that no more than the minimum necessary load is exerted during actuation, that is, during sliding, and also so that no more than the minimum necessary load is exerted during the swiveling of the door leaf, the guide elements which guide the door leaf in the rails are located approximately in the middle of the width of the door leaf. Thus the point at which the door leaf swivels is also in the middle of the leaf.

The design of the door leaf according to the invention is used especially for glass doors.

As a result of the integration of the door closer into the door leaf element, the inventive door leaf can also be completely preassembled at the factory, so that only a minor amount of installation work is required at the installation site. More specifically, the only work required to install the door leaf element according to the invention is to insert it into the upper and lower guide rails at the installation site.

An exemplary embodiment of the present invention is described below with reference to the figures:

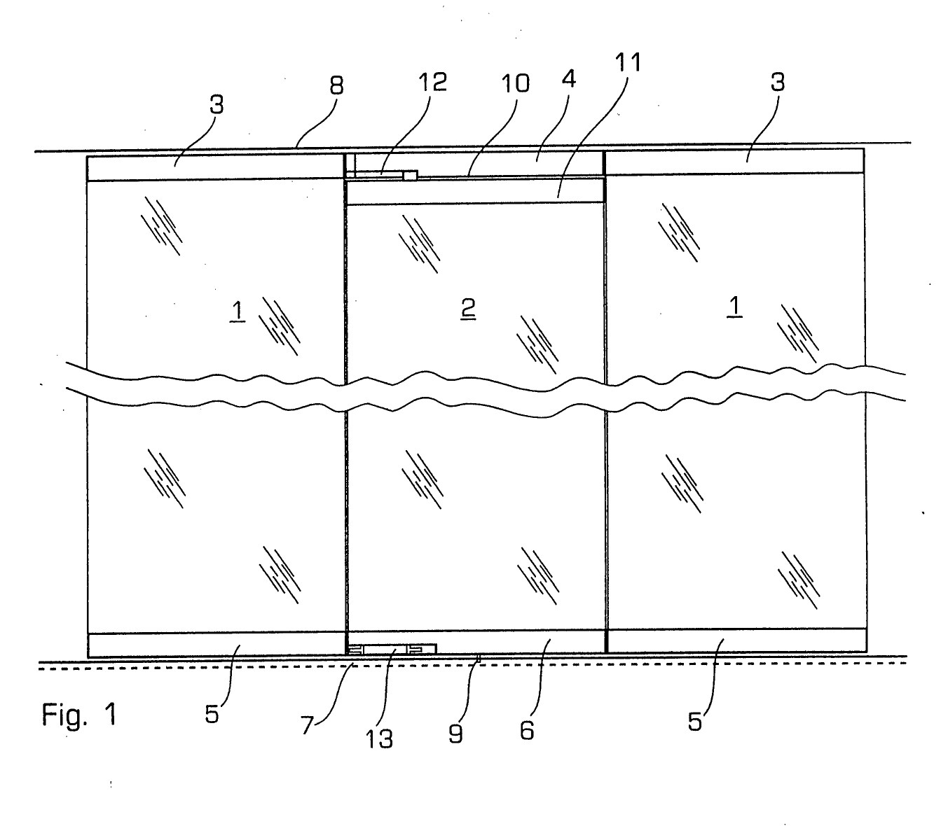

FIG. 1 shows a schematic diagram of a sliding wall system with a door leaf element according to the present invention, seen from the side;

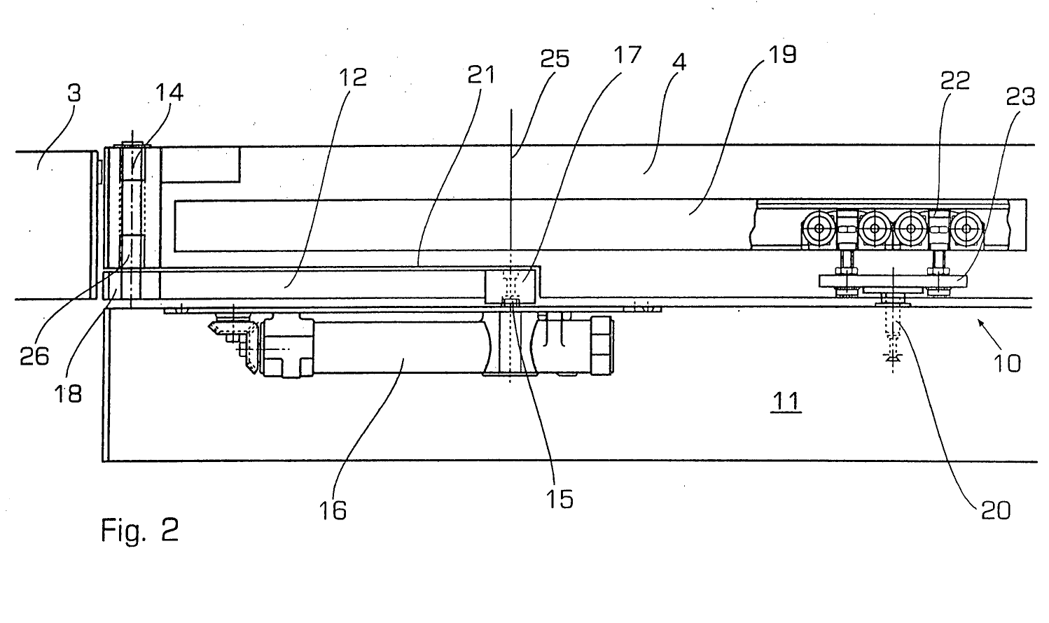

FIG. 2 shows a partially cut-away view of the top area of a door leaf element according to the invention;

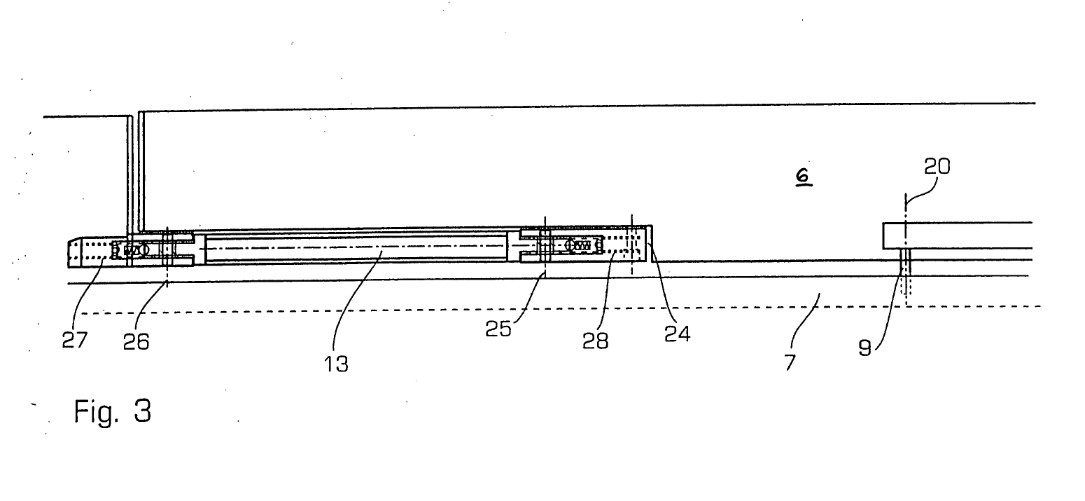

FIG. 3 shows a partially cut-away view of the bottom area of a door leaf element according to the invention;

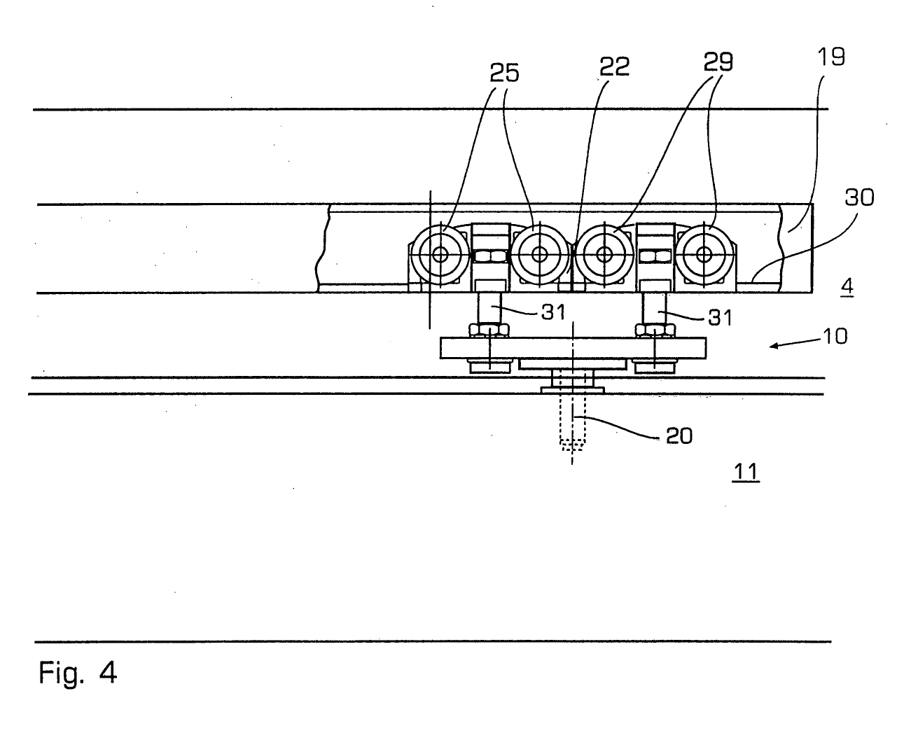

FIG. 4 shows an enlarged, side view of the carriage according to FIG. 2 along with its connection;

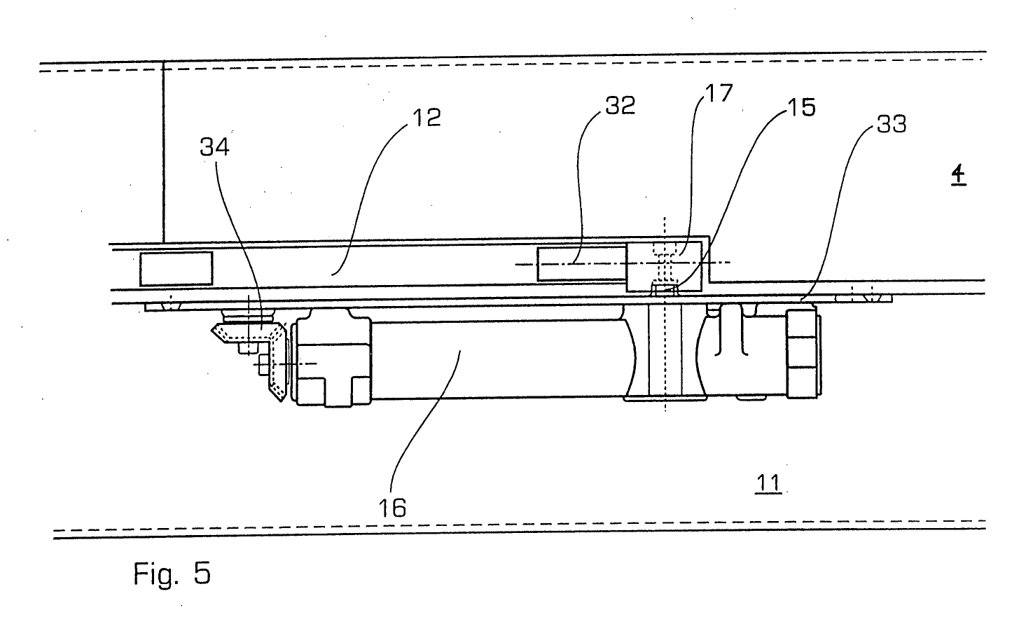

FIG. 5 shows an enlarged, side view of the door closer according to FIG. 2 along with its connection;

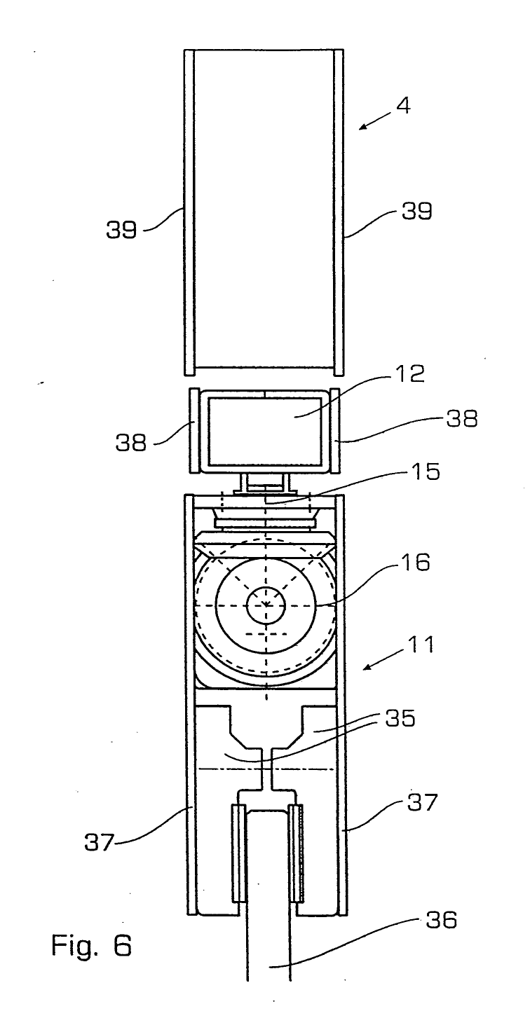

FIG. 6 shows a vertical cross section through the door closer according to FIG. 5;

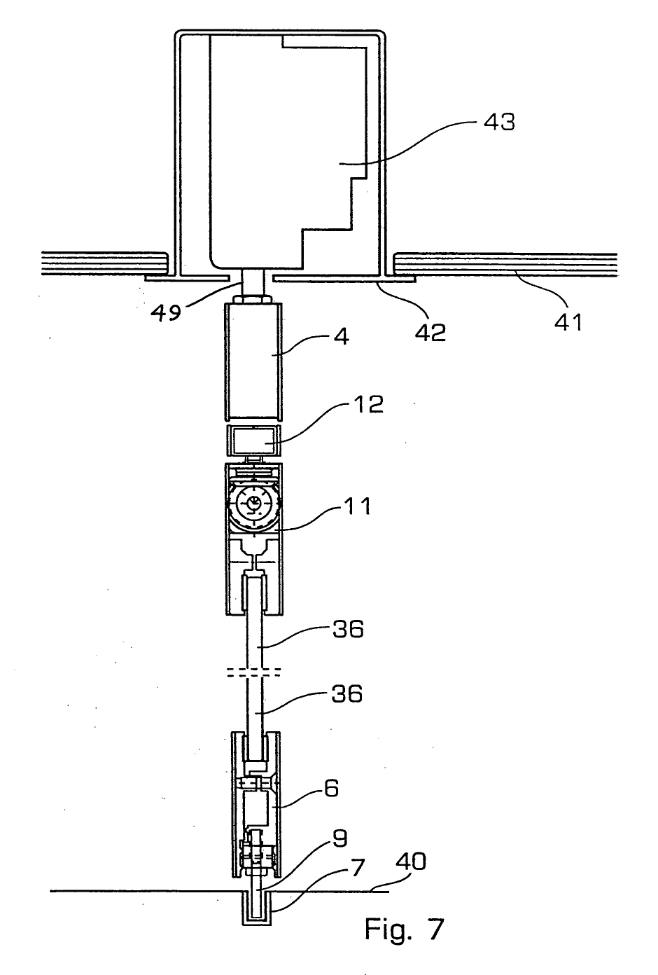

FIG. 7 shows a vertical cross section through the door leaf element according to the invention; and

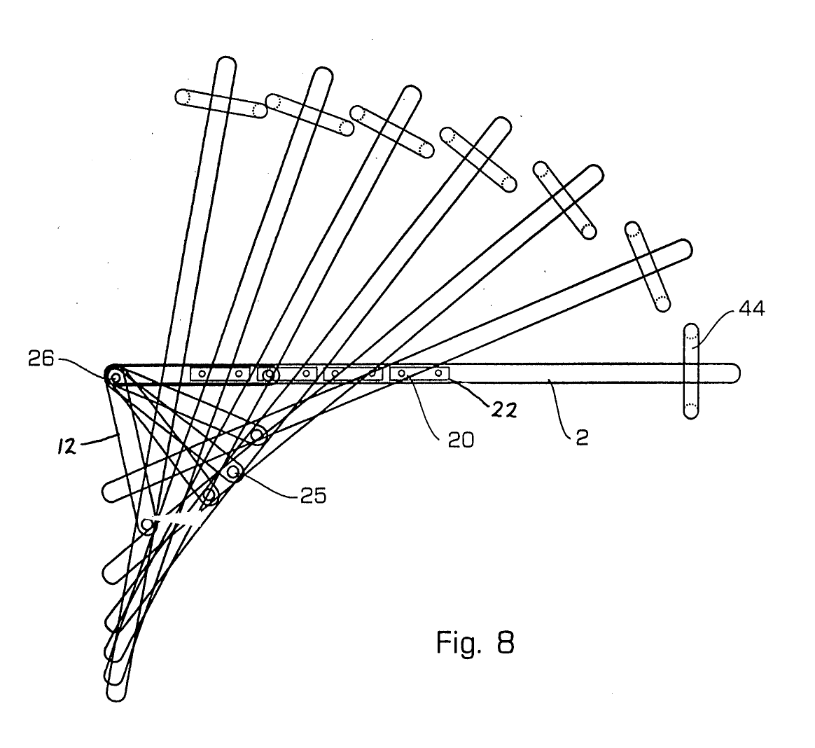

FIG. 8 shows a schematic diagram of the opening movement of the door leaf element according to the invention.

In the following, an exemplary embodiment of a door leaf element 2 according to the invention is described with reference to FIGS. 1-8; this leaf element forms part of a horizontally sliding wall consisting of individual elements.

As can be seen in FIG. 1, the door leaf element according to the invention is a glass door leaf, which has an upper profiled section 11 and a lower profiled section 6. In addition, the inventive door leaf element 2 has a leaf attachment part, which is also designed in the form of a profiled section (attachment section 4). The door leaf element 2 is able to swivel; that is, it can be used as a door, and it can also slide in the direction of its width. On each side of the door leaf element 2 is a door leaf element 1, which can only slide. Each of these adjacent elements has a leaf attachment part 3 at the top and a profiled cap section 5 at the bottom. The door leaf elements 1, 2 shown here are guided both in a ceiling suspension rail 8 and in a floor rail 7. As can be seen in FIG. 1, a guide pin 9 is provided on the door leaf element 2; this pin projects into the essentially U-shaped floor rail (compare FIG. 7). The floor rail 7 is flush-mounted into the floor 40.

As can also be seen in FIG. 1, the sliding and swiveling door leaf element 2 comprises a top actuating arm 12 and a bottom actuating arm 13, which are designed as levers. The top actuating arm 12 is shown in greater detail in FIG. 2, and the bottom actuating arm 13 is shown in greater detail in FIG. 3. As can be seen in FIG. 2, the top actuating arm 12 is connected to a door closer 16 at the door closer axis 15. The door closer 16 is installed in the leaf section 11 so that it is concealed. At its other end, the top actuating arm 12 is supported on a swivel bearing 14 by a bearing area 18. Thus an axis of rotation 26 is formed in the attachment section 4, around which the actuating arm 12 can rotate. In addition, a swivel axis 25, around which the leaf 2 can swivel, is present in the area of the door closer axis 15. So that the design can be made as compact as possible, the upper actuating arm 12 is installed in a cutout area 21 in the attachment section 4. The door closer 16 is supported by a bearing area 17 in the upper actuating arm 12.

The swinging mount 10 can also be seen in FIG. 2; this lies on a line with the lower guide pin 9. The swinging mount 10 consists essentially of a carriage 22, a carriage connector 23, another swivel axis 20 formed by a pin, and two connectors 31 (compare FIGS. 2 and 4). The swinging mount 10 is shown in detail in FIG. 4. The carriage 22 has several rollers 29, which roll along the support surface 30 of a runway rail 19. The runway rail 19 is mounted in the attachment section 4. Thus, according to the invention, a swivel axis 20 is formed by the pin here and by the lower guide pin 9. The door leaf element according to the invention therefore comprises a total of three swivel axes, namely, the axis of rotation 26 on the side of the door leaf element, around which the actuating arms 12, 13 swivel, and the actual swivel axes of the leaf 2, namely, the first swivel axis 20 and the second swivel axis 25.

The bottom actuating arm 13 is shown in greater detail in FIG. 3. As can be seen in FIG. 3, the bottom actuating arm 13 is also rotatably supported at one end (the left end in FIG. 3) on the axis of rotation 26. At the opposite end, the actuating arm is connected by the second swivel axis 25 to the leaf 2. The bottom actuating arm 13 is also mounted in a cutout area 24 in the bottom profiled section 6. Arresting devices 27 and 28, furthermore, are provided at the outward-facing ends of the swivel axes 25 and 26, so that the door leaf element 2 can be locked in place in any desired position.

FIG. 5 shows the door closer and its connection on an enlarged scale. As can been in FIG. 5, the door closer 16 is installed in the top leaf section 11 of the door leaf element so that it is concealed. A cylindrical pin connected to the door closer 16 is supported in a bearing 17 at one end of the actuating arm 12. As a result, the door closer axis 15 becomes the second swivel axis 25 of the door leaf element (compare FIG. 2). The top actuating arm 12 is connected to the bearing 17 by way of a fastening flange 32. A spring-loaded adjusting device 34 is also provided on the door closer 16. The door closer 16 is attached to a mounting rail 33 on the top leaf section 11 and can thus be preinstalled on the door leaf element. The design of the door closer 16 is illustrated again in FIG. 6. As can be seen clearly in FIG. 6, the door closer 16 is completely concealed inside the leaf section 11. In addition, the leaf section 11 also serves to cover the two clamping sections 35, which serve to hold a pane of glass 36. Elastic, rubbery intermediate pieces are provided between the clamping sections 35 and the pane of glass 36. For aesthetic reasons, a panel 37 is provided on both sides. A panel 38 is also provided on both sides of the top actuating arm 12, and another panel 39 is provided over the attachment section 4 (compare FIG. 6).

The overall design of the door leaf element according to the invention is shown again in FIG. 7. An electrical drive 43 is installed behind an upper panel 42, which the ceiling rail makes available. The drive 43 is mounted completely above the ceiling 41. As a result, the power lines, etc., can be laid easily and invisibly above the ceiling. The inventive door leaf element consists of the leaf attachment part 4 and the actual leaf itself, which is formed by the glass pane 36 and by the two leaf sections 11 and 6. The lever or actuating arm 12 is located between the leaf attachment part 4 and the leaf section 11. As can be seen in FIG. 7, the door leaf element 2 is guided at the bottom by the guide pin 9 and at the top by the pin extending into the ceiling, both pins being located in the middle of the width of the door leaf element 2. Because the door closer 16 is an integral part of the leaf 2, the door leaf element 2 according to the invention has none of the projecting parts which would be present if the door closer were installed in the floor. Only the guide rail 7 is flush-mounted in the floor 40.

FIG. 8 shows the sequence of movements which occurs when the door leaf element swivels. The closed starting position is designated by the reference number 2. On the end opposite the axis of rotation 26, a handle 44 is provided to facilitate the actuation of the door leaf element. As can be seen in FIG. 8, the main closing edge of the door leaf element, on which the handle 44 is located, describes an elliptical path. Thus the leaf swivels both around the first swivel axis 20, by which the door leaf element 2 is guided at both top and bottom, and also around the second swivel axis 25, which connects the top actuating arm 12 to the door closer 16 and the bottom lever arm 13 to the door leaf element 2. The second swivel axis 25 moves along a circular path around the axis of rotation 26 (compare FIG. 8). Thus, when the door leaf element according to the invention opens, a combination of a swiveling and a sliding movement occurs. The lever arms exert a powerful force on the door leaf element 2 and thus ensure that the element is guided effectively at both top and bottom. Because the lever arm also increases the closing force of the door closer 16, the door closer 16 can be made relatively small. It can therefore be installed relatively easily in the leaf section 11 and thus concealed. As can also be seen in FIG. 8, the first swivel axis 20 moves in a linear manner along the runway rail 19 in the direction toward the axis of rotation 26.

Thus, according to the invention, a sliding and swiveling door leaf 2 is provided, which can be used to particular advantage in a sliding wall system. Thus it is possible to move the sliding and swiveling door leaf 2 to any desired position, where it can then be swiveled and used as a door. As a result, many different concrete possibilities are obtained, especially for sliding wall systems intended for shops with front areas. As a result of the double guidance at top and bottom, glass in particular can be used as a construction material for the door leaf element 2, even though these types of doors are very heavy. In spite of their great weight, such doors can be actuated easily because of the use of the levers 12 and 13. In addition, the inventive door leaf element 2 also makes it possible to eliminate connecting elements projecting from the floor as they do in the case of the previously known sliding wall systems.

The preceding description of the exemplary embodiment serves only to illustrate the invention, not to limit it in any way. The invention can be modified and varied in many ways without exceeding the scope of the invention.

List of Reference Numbers

1 sliding leaf
2 sliding and swiveling leaf
3 leaf attachment part
4 profiled attachment section
5, 6 profiled bottom cap section
7 floor rail
8 ceiling suspension rail
9 guide pin
10 swinging mount
11 leaf section
12 top actuating arm
13 bottom actuating arm
14 swivel bearing
15 door closer axis
16 door closer
17,18 bearing area
19 runway rail
20 swivel axis
21 cutout area
22 carriage
23 carriage connection
24 cutout area
25 swivel axis
26 axis of rotation
27, 28 arresting device
29 rollers
30 support surface
31 connection
32 fastening flange
33 mounting rail
34 spring-loaded adjusting device
35 clamping section
36 pane of glass
37, 38, 39 panels
40 floor
41 ceiling
42 panel
43 drive
44 handle

1-18. (cancelled)

19. A door leaf assembly for a sliding wall system, wherein the door leaf assembly can slide along an upper guide rail and a lower guide rail, the door leaf assembly comprising:
a door leaf element having a first vertical swivel axis and a second vertical swivel axis;
top and bottom guide elements for guiding the door leaf assembly on respective upper and lower guide rails; and
a lever arm which can rotate about an axis of rotation, the lever arm being connected to the door leaf element at the second swivel axis.

20. A door leaf assembly as in claim 19 wherein the guide elements lie on the first swivel axis.

21. A door leaf assembly as in claim 19 further comprising a door closer inside the door leaf element, the door closer being connected to the lever arm at the second swivel axis.

22. A door leaf assembly as in claim 19 wherein the guide elements are located centrally in the door leaf assembly.

23. A door leaf assembly as in claim 19 further comprising a top leaf section and a bottom leaf section, one of the sections having an opening which receives the lever arm.

24. A door leaf assembly as in claim 21 further comprising a top leaf section and a bottom leaf section, the door closer element being installed in the top leaf section.

25. A door leaf assembly as in claim 19 wherein the door leaf element is a first door leaf element, the assembly further comprising a second door leaf element adjacent to the first door leaf element, the second door leaf element having at least one swivel bearing in which the first door leaf element is journaled for rotation.

26. A door leaf assembly as in claim 19 further comprising an attachment section which slides along the top guide rail, the door leaf element swiveling about the first swivel axis with respect to the attachment section.

27. A door leaf assembly as in claim 26 wherein the attachment section has an opening which receives the lever arm.

28. A door leaf assembly as in claim 26 wherein the attachment section has a swivel bearing in which the door leaf element is journaled for rotation.

29. A door leaf assembly as in claim 26 wherein the carriage comprises a runway rail, the assembly further comprising a carriage which can travel on the runway rail, the door leaf element swiveling about the first swivel axis with respect to the carriage.

30. A door leaf assembly as in claim 19 wherein the door leaf element is a first door leaf element, the assembly further comprising at least one additional door leaf element adjacent to the first door leaf element, all of the door leaf elements being guided in the upper and lower rails.

31. A door leaf assembly as in claim 19 further comprising at least one arresting device for locking the door element in place, the arresting device being located in the door leaf element.

32. A door leaf assembly as in claim 19 wherein the door leaf element has a width, the first swivel axis being located centrally in the width.

33. A door leaf assembly as in claim 19 wherein the door leaf element comprises a glass panel.
